(19) United States
(12) Patent Application Publication
(10) Pub. No.: US 2022/0360103 A1
(43) Pub. Date: Nov. 10, 2022

(54) BATTERY CHARGING

(71) Applicant: Nicoventures Trading Limited, London (GB)

(72) Inventors: Tomi VINTOLA, London (GB); Martin MULLIN, London (GB); Terry ANGELL, London (GB)

(21) Appl. No.: 17/755,198

(22) PCT Filed: Oct. 23, 2020
(86) PCT No.: PCT/GB2020/052684

§ 371 Date: Apr. 22, 2022

(30) Foreign Application Priority Data
Oct. 25, 2019 (GB) 1915511.8

(51) Int. Cl. H02J 7/00; A24F 40/90; A24F 40/50

(52) U.S. Cl. CPC H02J 7/007194; A24F 40/90; A24F 40/50

(57) ABSTRACT

An apparatus for a non-combustible aerosol provision system is described comprising: a charging unit configured to charge a battery of said aerosol provision system; a circuit comprising a control module, wherein the control module outputs a first control signal having a charge enable state and a charge disable state; and a protection module configured to decouple the circuit from said battery when the battery voltage is below a first threshold level. The charging unit is configured to charge the battery unless the first control signal has the charge disable state.

### PRIORITY CLAIM

The present application is a National Phase entry of PCT Application No. PCT/GB2020/052684, filed Oct. 23, 2020, which claims priority from United Kingdom Application No. 1915511.8, filed Oct. 25, 2019, each of which is hereby fully incorporated herein by reference.

### TECHNICAL FIELD

The present specification relates to an arrangement for charging a battery, such as a battery of an aerosol provision system.

### BACKGROUND

Smoking articles, such as cigarettes, cigars and the like burn tobacco during use to create tobacco smoke. Attempts have been made to provide alternatives to these articles by creating products that release compounds without combusting. For example, a range of non-combustible aerosol provision systems exist that release compounds from an aerosolizable material without combusting the aerosolizable material, such as electronic cigarettes, tobacco heating products, and hybrid systems to generate aerosol using a combination or aerosolizable materials.

### SUMMARY

In a first aspect, this specification describes an apparatus for a non-combustible aerosol provision system comprising: a charging unit configured to charge a battery of said aerosol provision system; a circuit comprising a control module, wherein the control module outputs a first control signal having a charge enable state and a charge disable state; and a protection module configured to decouple the circuit from said battery when the battery voltage is below a first threshold level (e.g. 2.5V), wherein the charging unit is configured to charge the battery unless the first control signal has the charge disable state. The control module may have an MPU, CPU or similar module. The protection module may be implemented using a protection circuit module (PCM).

The protection module may be configured to prevent the battery from being charged when the battery voltage is below a second threshold level (e.g. 0.9V or 1V), wherein the second threshold level is lower than the first threshold level. This functionality may be based on the internal implementation of a PCM implementing the protection module.

The protection circuit may be configured to permanently decouple the circuit from said battery when the battery voltage is below a/the second threshold level, wherein the second threshold level is lower than the first threshold level. This functionality may be based on the internal implementation of a PCM implementing the protection module.

The control module may be configured to output a charge current control signal. Furthermore, a charging current output by the charging unit to charge the battery may be dependent, at least in part, on the charge current control signal. The charging current output may be set to a default level in the absence of the charge current control signal (i.e. if the charge control signal output of the control module is “floating”). The default level may be a lowest current level (e.g. for maximum safety). In one implementation, the default level is 70 mA. The charge current control signal may be dependent, at least in part, on a temperature of said battery.

The control module may be configured to set the first control signal to the charge enable state or the charge disable state based, at least in part, on a determined (e.g. measured) temperature of said battery.

The control module may be configured to set the first control signal to the charge disable state when the apparatus is used to generate an aerosol.

Some embodiments further comprise a resistor arrangement, wherein the resistor arrangement is configured to receive the first control signal from the control module and to receive a constant current source signal from the charging unit, wherein the constant current source signal generates a voltage within the resistor arrangement dependent on said first control signal, said voltage being used, by said charging unit, to determine whether to allow charging of said battery. The resistor arrangement may comprise: a first resistor having a first terminal configured to receive the constant current source signal and a second terminal connected to ground; and a second resistor having a first terminal configured to receive the constant current source signal and a second terminal configured to receive the first control signal. In one example implementation, the first and second resistors are 10kΩ and 330Ω resistor respectively, however this is not essential to all embodiments. The resistors may be selected to provide a given voltage (e.g. of the order of at least 150 mV).

Some embodiments further comprise a regulator configured to regulate an operational voltage provided to said circuit. The operation voltage may provide a fixed voltage to the circuit. In one embodiment, the operational voltage is 2.5V.

The control module may be configured to control an aerosol generation circuit of said apparatus.

In some embodiments, the apparatus further comprises the said battery.

In a second aspect, this specification describes a method comprising: decoupling (e.g. using a protection module, such as a protection circuit module (PCM)) a circuit from a battery of a non-combustible aerosol provision system in the event that the battery voltage is below a first threshold level (e.g. 2.5V), wherein the circuit comprises a control module; using said control module to generate a first control signal, the first control signal having a charge enable state and a charge disable state; and charging (e.g. using a charging unit) the battery unless the first control signal has the charge disable state. The control signal may have neither the charge enable state nor the charge disable state in the event that the circuit is decoupled from the battery.

The method may further comprising preventing the battery from being charged when the battery voltage is below a second threshold level (e.g. 0.9V or 1V), wherein the second threshold level is lower than the first threshold level.

The method may further comprise permanently decoupling the circuit from said battery in the event that the battery voltage is below a second threshold level, wherein the second threshold level is lower than the first threshold level.

The method may further comprise: generating a voltage within a resistor arrangement dependent on said first control signal; and determining whether to charge the battery depending on said generated voltage.

The method may comprise providing a charge current control signal. Furthermore, a charging current for charging the battery may be dependent, at least in part, on the charge current control signal. The method may comprise setting the charging current output to a default level in the absence of the charge current control signal (i.e. if the charge control signal output of the control module is “floating”). The default level may be a lowest current level (e.g. for maximum safety). In one implementation, the default level is 70 mA.

The charge current control signal may be dependent, at least in part, on a temperature of said battery.

In a third aspect, this specification describes a non-combustible aerosol provision system (e.g. for generating an aerosol from an aerosolizable material), the aerosol provision system comprising an apparatus including any of the features of the first aspect described above or configured to operate in accordance with any of the features of the second aspect described above. The aerosol provision system may be configured to receive a removable article comprising an aerosol generating material.

In a fourth aspect, this specification describes computer-readable instructions which, when executed by computing apparatus, cause the computing apparatus to perform any method as described with reference to the second aspect.

In a fifth aspect, this specification describes a kit of parts comprising an article for use in a non-combustible aerosol generating system, wherein the non-combustible aerosol generating system comprising an apparatus including any of the features of the first aspect described above or configured to operate in accordance with any of the features of the second aspect described above. The article may, for example, be a removable article comprising an aerosol generating material.

In a sixth aspect, this specification describes a computer program comprising instructions for causing an apparatus to perform at least the following: decouple a circuit from a battery of a non-combustible aerosol provision system in the event that the battery voltage is below a first threshold level; generate a first control signal, the first control signal having a charge enable state and a charge disable state; and charge the battery unless the first control signal has the charge disable state.

### BRIEF DESCRIPTION OF THE DRAWINGS

Example embodiments will now be described, by way of example only, with reference to the following schematic drawings, in which:

FIG. 1 is a block diagram of a system in accordance with an example embodiment;

FIG. 2 is a flow chart showing an algorithm in accordance with an example embodiment FIG. 3 is a block diagram of a system in accordance with an example embodiment;

FIG. 4 is a flow chart showing an algorithm in accordance with an example embodiment;

FIG. 5 is a flow chart showing an algorithm in accordance with an example embodiment;

FIG. 6 is a block diagram of a circuit in accordance with an example embodiment;

FIG. 7 is a flow chart showing an algorithm in accordance with an example embodiment;

FIG. 8 is a flow chart showing an algorithm in accordance with an example embodiment;

FIG. 9 is a block diagram of a circuit in accordance with an example embodiment; and

FIG. 10 is a block diagram of a non-combustible aerosol provision device in accordance with an example embodiment.

### DETAILED DESCRIPTION OF THE DRAWINGS

As used herein, the term “delivery system” is intended to encompass systems that deliver a substance to a user, and includes:
combustible aerosol provision systems, such as cigarettes, cigarillos, cigars, and tobacco for pipes or for roll-your-own or for make-your-own cigarettes (whether based on tobacco, tobacco derivatives, expanded tobacco, reconstituted tobacco, tobacco substitutes or other smokable material);

non-combustible aerosol provision systems that release compounds from an aerosolizable material without combusting the aerosolizable material, such as electronic cigarettes, tobacco heating products, and hybrid systems to generate aerosol using a combination of aerosolizable materials;

articles comprising aerosolizable material and configured to be used in one of these non-combustible aerosol provision systems; and

aerosol-free delivery systems, such as lozenges, gums, patches, articles comprising inhalable powders, and smokeless tobacco products such as snus and snuff, which deliver a material to a user without forming an aerosol, wherein the material may or may not comprise nicotine.

According to the present disclosure, a “combustible” aerosol provision system is one where a constituent aerosolizable material of the aerosol provision system (or component thereof) is combusted or burned in order to facilitate delivery to a user.

According to the present disclosure, a “non-combustible” aerosol provision system is one where a constituent aerosolizable material of the aerosol provision system (or component thereof) is not combusted or burned in order to facilitate delivery to a user.

In embodiments described herein, the delivery system is a non-combustible aerosol provision system, such as a powered non-combustible aerosol provision system.

In one embodiment, the non-combustible aerosol provision system is an electronic cigarette, also known as a vaping device or electronic nicotine delivery system (END), although it is noted that the presence of nicotine in the aerosolizable material is not a requirement.

In one embodiment, the non-combustible aerosol provision system is a tobacco heating system, also known as a heat-not-burn system.

In one embodiment, the non-combustible aerosol provision system is a hybrid system to generate aerosol using a combination of aerosolizable materials, one or a plurality of which may be heated. Each of the aerosolizable materials may be, for example, in the form of a solid, liquid or gel and may or may not contain nicotine. In one embodiment, the hybrid system comprises a liquid or gel aerosolizable material and a solid aerosolizable material. The solid aerosolizable material may comprise, for example, tobacco or a non-tobacco product.

Typically, the non-combustible aerosol provision system may comprise a non-combustible aerosol provision device and an article for use with the non-combustible aerosol provision system. However, it is envisaged that articles which themselves comprise a mechanism for powering an aerosol generating component may themselves form the non-combustible aerosol provision system.

In one embodiment, the non-combustible aerosol provision device may comprise a power source and a controller. The power source may be an electric power source or an exothermic power source. In one embodiment, the exothermic power source comprises a carbon substrate which may be energized so as to distribute power in the form of heat to an aerosolizable material or heat transfer material in proximity to the exothermic power source. In one embodiment, the power source, such as an exothermic power source, is provided in the article so as to form the non-combustible aerosol provision.

In one embodiment, the article for use with the non-combustible aerosol provision device may comprise an aerosolizable material, an aerosol generating component, an aerosol generating area, a mouthpiece, and/or an area for receiving aerosolizable material.

In one embodiment, the aerosol generating component is a heater capable of interacting with the aerosolizable material so as to release one or more volatiles from the aerosolizable material to form an aerosol. In one embodiment, the aerosol generating component is capable of generating an aerosol from the aerosolizable material without heating. For example, the aerosol generating component may be capable of generating an aerosol from the aerosolizable material without applying heat thereto, for example via one or more of vibrational, mechanical, pressurization or electrostatic mechanism.

In one embodiment, the aerosolizable material may comprise an active material, an aerosol forming material and optionally one or more functional materials. The active material may comprise nicotine (optionally contained in tobacco or a tobacco derivative) or one or more other non-olfactory physiologically active materials. A non-olfactory physiologically active material is a material which is included in the aerosolizable material in order to achieve a physiological response other than olfactory perception.

The aerosol forming material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more functional materials may comprise one or more of flavors, carriers, pH regulators, stabilizers, and/or antioxidants.

In one embodiment, the article for use with the non-combustible aerosol provision device may comprise aerosolizable material or an area for receiving aerosolizable material. In one embodiment, the article for use with the non-combustible aerosol provision device may comprise a mouthpiece. The area for receiving aerosolizable material may be a storage area for storing aerosolizable material. For example, the storage area may be a reservoir. In one embodiment, the area for receiving aerosolizable material may be separate from, or combined with, an aerosol generating area.

Aerosolizable material, which also may be referred to herein as aerosol generating material, is material that is capable of generating aerosol, for example when heated, irradiated or energized in any other way. Aerosolizable material may, for example, be in the form of a solid, liquid or gel which may or may not contain nicotine and/or flavorants. In some embodiments, the aerosolizable material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it.

The aerosolizable material may be present on a substrate. The substrate may, for example, be or comprise paper, card, paperboard, cardboard, reconstituted aerosolizable material, a plastics material, a ceramic material, a composite material, glass, a metal, or a metal alloy.

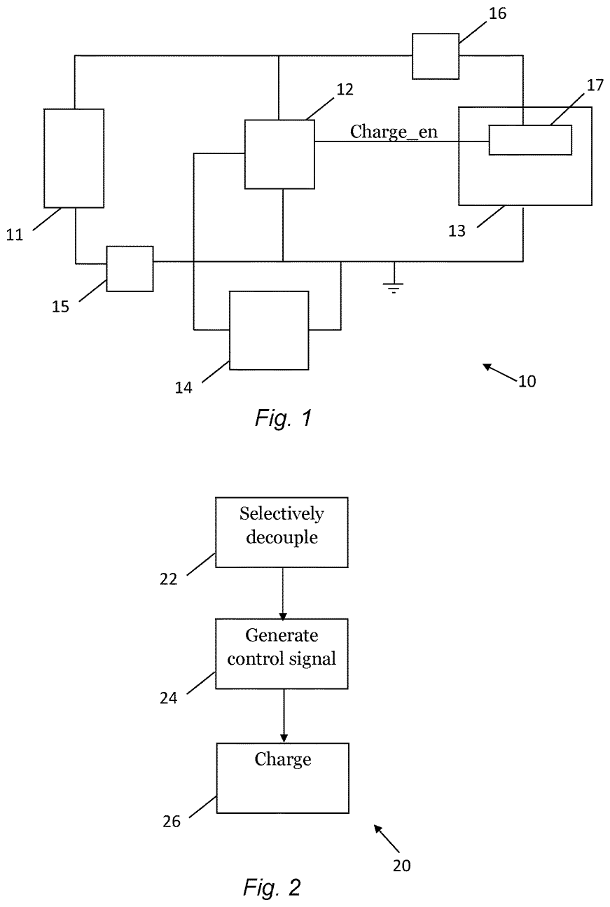

FIG. 1 is a block diagram of a system, indicated generally by the reference numeral 10, in accordance with an example embodiment.

The system 10 comprises a battery 11, a charging unit 12, a circuit 13, a power supply 14, a protection module 15 and a regulator 16. The circuit 13 has a control module 17 (such as an MCU, CPU or some other processor). The protection module 15 may be a protection circuit module (PCM).

The circuit 13 may form part of a non-combustible aerosol provision system. The system 10 enables the control module 17 to control charging of the battery 11, such that the battery 11 can be used to power the circuit 13 (and can be used to power the aerosol provision system).

The power supply 14 may be an external power supply that may be temporarily connected to the charging unit 12 to enable charging of the battery 11. The power supply 14 may be attached to the system 10 using a connector, such as a USB connector. Many alternative connector arrangements and many other charging arrangements will be readily apparent to persons skilled in the art.

The charging unit 12 is configured to charge the battery 11. The control module 17 provides a control signal (charge_en) to the charging unit 12, wherein the control signal has a charge enable state and a charge disable state. As discussed in detail below, the charging unit 12 is configured to charge the battery 11 unless the control signal is in the charge disable state. Thus, if the first control signal is “floating” (such that the first control signal has neither the charge enable state nor the charge disable state), then the charging unit 12 is still configured to charge the battery 11.

The protection module 15 is provided to decouple the power source (the battery 11) from the rest of the system 10 (in particular the circuit 13) in certain defined conditions. These may include one or more of: an overvoltage condition, an undervoltage condition and an overcurrent condition. In one example embodiment, the protection module 15 decouples the circuit 13 from the battery 11 in the event that the battery voltage is below a first threshold voltage. This may be provided a safety feature, since using the battery 11 to power an aerosol provision system when the battery voltage is too low can cause problems.

The regulator 16 provides a fixed voltage to part of the circuit 13. For example, in one example embodiment, the circuit 13 operates at 2.5V, with that voltage being provided by the regulator 16.

The first threshold voltage at which the protection module 15 decouples the battery 11 from the circuit 13 may be set at about 2.5V. As a result of the decoupling, the rate at which current from the battery will be drained will be reduced, thereby making it less likely that the battery will fall below a second threshold voltage below which the battery may be permanently decoupled from the circuit 13 (as discussed further below). Moreover, as noted above, the circuit 13 may operate at 2.5V, thus if the battery voltage provided to the circuit 13 drops below 2.5V (or whatever the relevant operational voltage is), then coupling the battery voltage to the circuit 13 may lead to unstable operation of the circuit.

FIG. 2 is a flow chart showing an algorithm, indicated generally by the reference numeral 20, in accordance with an example embodiment. The algorithm 20 may be implemented by the system 10 described above.

The algorithm 20 starts at operation 22, where the circuit 13 is selectively decoupled from the battery 11 of the system 10. Specifically, the circuit 13 is decoupled (e.g. using the protection circuit 15) from the battery 11 in the event that the battery voltage is below a first threshold voltage level.

At operation 24, a first charge control signal is generated by the circuit 13 (e.g. by the control module 17). As discussed above, the first control signal has a charge enable state and a charge disable state. However, in the event that the circuit is decoupled from the battery (and therefore not powered), the first control signal will be floating, such that the first control signal has neither the charge enable state nor the charge disable state.

At operation 26, the battery 11 is charged (using the charging unit 12) unless the first control signal has the charge disable state. Thus, if the first control signal has the charge enable state, or the first control signal is floating (as discussed above), then the battery 11 may be charged in the operation 26 (provided, of course, that a suitable charging arrangement, such as the power supply 14, is provided).

FIG. 3 is a block diagram of a system, indicated generally by the reference numeral 30, in accordance with an example embodiment. The system 30 includes the charging unit 12 and the control module 17 described above. The system 30 further comprises a resistor arrangement 32 provided between the charging unit 12 and the control module 17. The resistor arrangement 32 is configured to receive the first control signal (charge_en) from the control module 17 and to receive a constant current source signal from the charging unit 12 (e.g. from a TS pin of the charging unit 12, as shown in FIG. 3). As discussed further below, the constant current source signal can be used to generate a voltage within the resistor arrangement 32 that is dependent on the first control signal (charge_en), that generated voltage being used, by the charging unit 12, to determine whether to allow charging of the battery 11 described above.

In the example system 30, the resistor arrangement 32 comprises: a first resistor 34 having a first terminal connected to the TS pin of the charging unit 12 (i.e. to the constant current source) and a second terminal connected to ground; and a second resistor 35 having a first terminal connected to the TS pin of the charging unit 12 (i.e. to the constant current source) and a second terminal connected to the first control signal (charge_en). In one example implementation, the first resistor 34 has a resistance of 10kΩ and the second resistor 35 has a resistance of 330Ω (of course, these resistors could have different values in alternative embodiments).

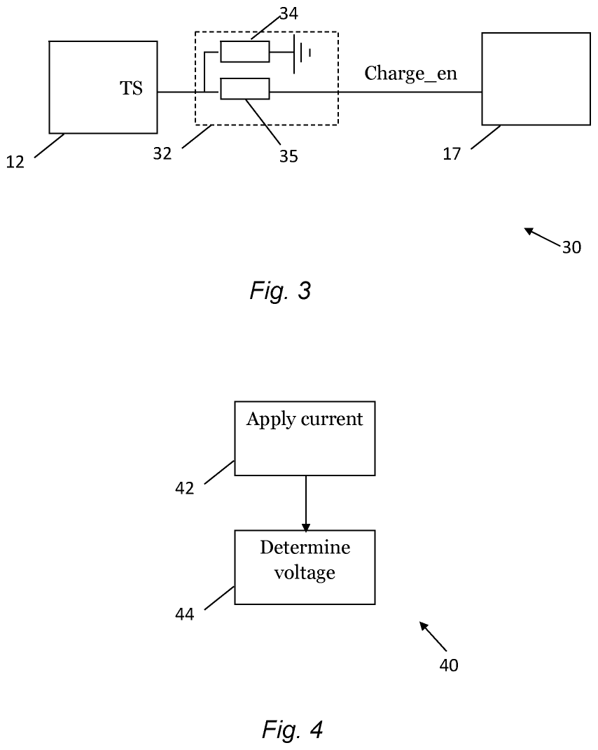

FIG. 4 is a flow chart showing an algorithm, indicated generally by the reference numeral 40, in accordance with an example embodiment. The algorithm 40 may be implemented by the system 30 described above.

The algorithm 40 starts at operation 41, where a constant current is output by the TS terminal of the charging unit 12. In one example embodiment, the constant current is 50 μA.

At operation 44, a voltage at the TS terminal of the charging unit 12 is determined. On the basis of the determined voltage, a determination is made regarding the state of the charge_en control signal. It should be noted that there may not be a “determination” of the state of the charge_en control signal; rather, action may occur simply based on the voltage generated across the resistor arrangement 32.

In the example described above, if the charge_en signal is floating, then the 50 μA current flows through the 10kΩ resistor to ground, resulting in a voltage of 500 mV at the TS pin of the charging unit 12. This voltage is sufficient to enable the charging unit 12, such that the battery can be charged in the event that the circuit 13 is decoupled from the battery (see operation 22 above), such that the battery can be charged (see operation 26 above).

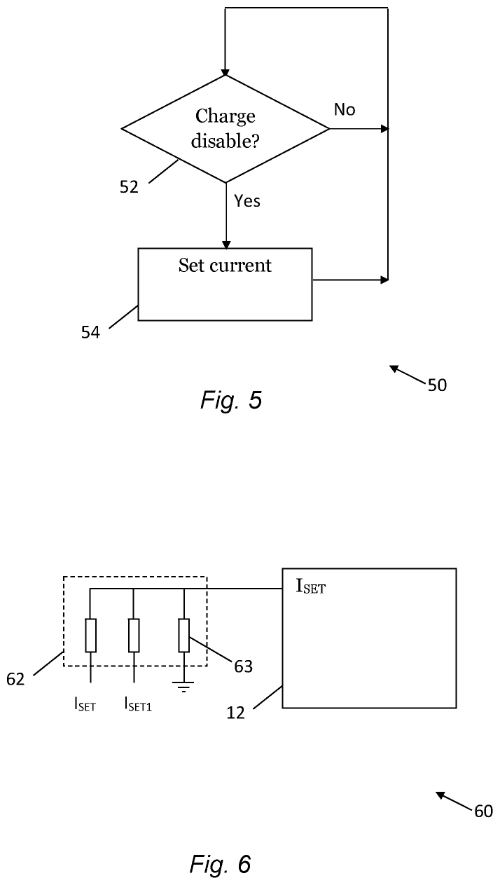

FIG. 5 is a flow chart showing an algorithm, indicated generally by the reference numeral 50, in accordance with an example embodiment. The algorithm 50 is an example implementation of the operation 26 of the algorithm 20 described above.

The algorithm 50 starts at operation 52, where a determination is made regarding whether the state of the control signal (charge_en) received at the charging unit 12 from the control module 17 is in the charge disable state. If the control signal has the charge disable state, then the operation 52 is simply repeated; otherwise (if the control signal has the charge enable state or is floating), the algorithm moves to operation 54. As noted above, there may not be a “determination” of the state of the charge_en control signal; rather, action may occur simply based on the voltage generated across the resistor arrangement 32.

At operation 54, a charging current output by the charging unit 12 to charge the battery 11 is set. As described below, the charging current output by the charging unit 12 to charge the battery 11 may be dependent, at least in part, on a charge current control signal I_{SET}.

The charging current output may be set in operation 54 to a default level in the absence of a charge current control signal (e.g. I_{SET}). For example, the default level may be a low level (e.g. 70 mA) that may be used in a default condition. The default level may, for example, be used if the control module 17 is decoupled from the battery 11.

FIG. 6 is a block diagram of a circuit, indicated generally by the reference numeral 60, in accordance with an example embodiment. The circuit 60 comprises the charging unit 12 described above, which charging unit includes an input pin I_{SET}. The voltage received at the input pin I_{SET} may be used to determine the charging current applied in the operation 26 of the algorithm 20.

The voltage at the input pin I_{SET} may be dependent on the state of two control signals: I_{SET} and I_{SET1}. Those control signals may be provided to a resistor arrangement 62. The control signals I_{SET} and I_{SET1} may be provided by the control module 17, such that the control module 17 may set whether charging is enabled by setting the first control signal (charge_en) and, if charging is enabled, may set the charging level by setting the control signals I_{SET} and I_{SET1}. Of course, as noted above, the control module 17 may be decoupled from the battery 11 such that the control signals I_{SET} and I_{SET1} may, in some circumstances, be floating.

In one example embodiment, the charge current is set in the operation 26 in accordance with the following logic:

If I_{SET} and I_{SET1} are floating, the charge current is set to a low level (e.g. 70 mA). This state may readily be detected by virtue of a grounded resistor 63 of the resistor arrangement 62.
If I_{SET} is floating and I_{SET1} is low, the charge current is set to a medium level (e.g. 175 mA).
If I_{SET} is low and I_{SET1} is floating, the charge current is set to a high level (e.g. 700 mA).

Of course the number of options described above, and the parameters (e.g. current levels) of those options are provided by way of example only; many variants are possible.

Alternatively, or in addition, to the algorithm 50, the charge current output may be dependent, at least in part, on a temperature of the battery 11. For example, a negative temperature coefficient resistor (NTC) may be provided as part of a battery temperature monitoring algorithm.

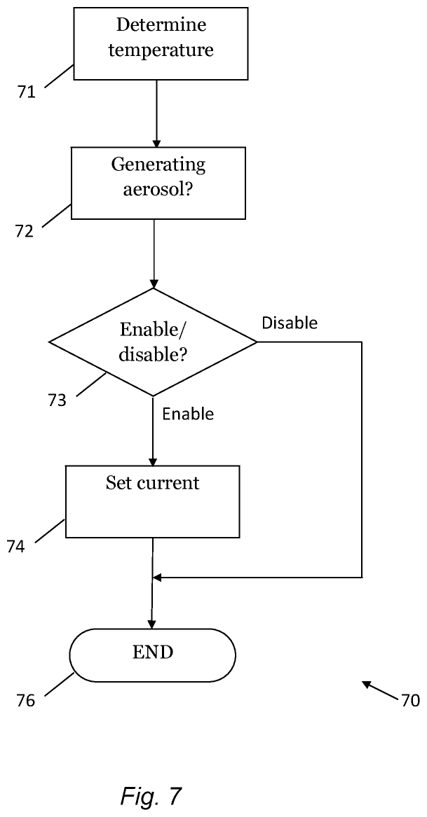

FIG. 7 is a flow chart showing an algorithm, indicated generally by the reference numeral 70, in accordance with an example embodiment. The algorithm 70 may, for example, be implemented by the control module 17.

The algorithm 70 starts at operation 71, where a temperature of operation is determined (e.g. measured). For example, the operation 71 may determine the temperature of the battery 11.

The operation 71 may be implemented in many ways, for example using a thermocouple or an NTC resistor.

At operation 72 of the algorithm 70, it is determined whether the system 10 is being used to generate an aerosol. For example, a determination may be made regarding whether a user is activating the device (e.g. taking a puff).

At operation 73 of the algorithm 70, a decision is taken regarding whether charging of the battery 11 should be enabled or disabled. For example, if the temperature (e.g. of the battery) is high (as determined in operation 71), then charging may be disabled. Alternatively, or in addition, if the system is generating an aerosol (as determined in operation 72), then charging may be disabled. Otherwise, charging of the battery may be enabled. Of course, other factors (instead of, or in addition to, one or more of the factors discussed with reference to operations 71 and 72) may be taken into account when determine whether or not to enable battery charging.

If battery charging is disabled in the operation 73, then the first control signal discussed above is set to the charge disable state and the algorithm 70 terminates at operation 76. If the battery charging is enabled in the operation 73, then said first control signal is set to the charge enable state and the algorithm 70 moves to operation 74, where the current charging level is set.

The current charging level may be set in operation 74 in a number of ways (and may be implemented by setting the control signals I_{SET} and I_{SET1}, as discussed above). For example, the current charging level may be dependent (at least in part) on the temperature of the battery 11. Alternatively, or in addition, the current charging level may be dependent on how long the charging process has been in operation (e.g. the charging level may increase over time). Other factors could also be taken into account.

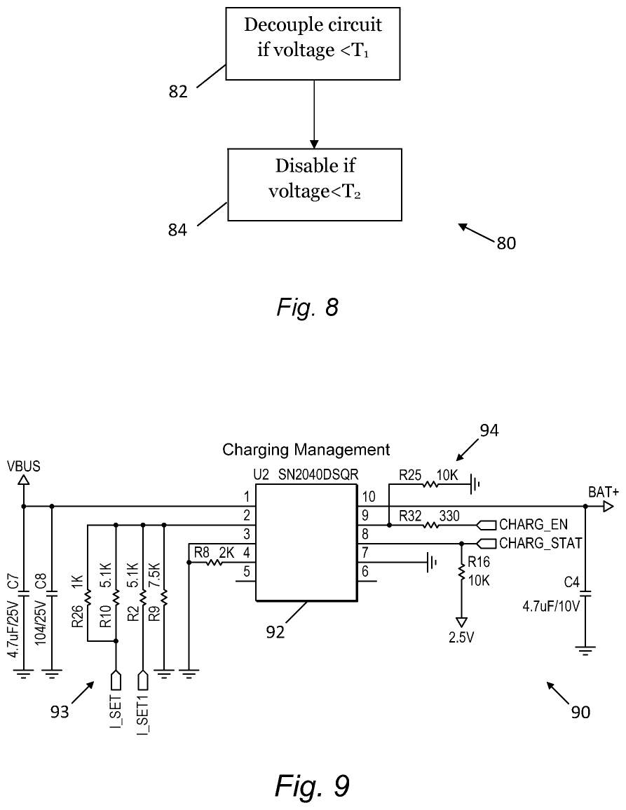

FIG. 8 is a flow chart showing an algorithm, indicated generally by the reference numeral 80, in accordance with an example embodiment.

The algorithm 80 starts at operation 82, where the circuit 13 (and hence the control module 17) is decoupled from the battery 11 in the event that the battery voltage is below a first threshold level (T¹). As discussed above, with the control circuit decoupled, it may still be possible to charge the battery, such that the battery voltage level can rise about the first threshold level. At that stage, the circuit 13 may be coupled to the battery again and normal operation resumed.

At operation 84, the system 10 is disabled in the event that the battery voltage is below a second threshold (T₂). Disabling the system may involve permanently decoupling the circuit 13 from said battery 11 when the battery voltage is below the second threshold level, wherein the second threshold level is lower than the first threshold level. The protection module 15 may be provided with a feature that prevents the battery 11 from being charged in the event that the battery voltage drops below the first threshold, even if a charging source (such as the power supply 14) is attached.

It should be noted that although the algorithm 80 is shown with two separate operations, the operations 82 and 84 may, in practice, be implemented at the same time. Moreover, the operations 82 and 84 may be implemented in an ongoing fashion. In one example embodiment, the operations 82 and 84 are implemented by the protection module 15 on the basis of the battery voltage.

FIG. 9 is a block diagram of a circuit, indicated generally by the reference numeral 90, in accordance with an example embodiment. The circuit 90 includes a charging management module 92. The module 92 is an example of the charging module 12 described above.

The charging management module 92 includes a number of pins, some of which are described below.

A first pin (IN) is configured to receive a voltage VBUS from a power supply (when connected). For example, the power supply 14 described above may be selectively connectable to the first pin (IN).

A second pin (ISET) receives a current setting voltage. A resistor arrangement 93 (similar to the resistor arrangement 62 described above) converts control signals I_{SET} and I_{SET1} (as output, for example, by the control circuit 17) into the current setting voltage at the second pin ISET.

A ninth pin (TS) receives a charging control signal. A resistor arrangement 94 (similar to the resistor arrangement 32 described above) converts a charge_en control signal (as output, for example, by the control circuit 17) into the charging control signal.

A tenth pin (OUT) provides a charging current to a battery (such as the battery 11 described above).

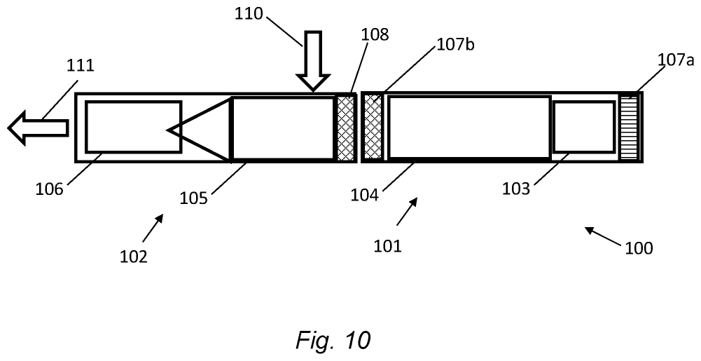

FIG. 10 is a block diagram of a non-combustible aerosol provision device, indicated generally by the reference numeral 100, in accordance with an example embodiment. The device 100 is a modular device, comprising a first part 101 and a second part 102.

The first part 101 of the device 100 includes a control circuit 103 (which may include at least some of the charging unit 12, the circuit 13, the protection module 15, the regulator 16 and the control module 17 described above) and a battery 104 (such as the battery 11 described above). The second part 102 of the device 100 includes a heater 105 and a liquid reservoir 106.

The first part 101 includes a first connector 107a (such as a USB connector). The first connector 107a may enable connection to be made to a power source (such as the power source 14 described above) for charging the battery 104 (e.g. under the control of the control circuit 103).

The first part 101 also includes a second connector 107b that can be removably connected to a first connector 108 of the second part 102.

In the use of the device 100, air is drawn into an air inlet of the heater 105, as indicated by the arrow 110. The heater is used to heat the air (e.g. under the control of the circuit 103). The heated air is directed to the liquid reservoir 106, where an aerosol is generated. The aerosol exits the device at an air outlet, as indicated by the arrow 111 (for example into the mouth of a user of the device 100).

Of course, the device 100 is provided by way of example only; many variants and alternatives are possible.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

1. An apparatus for a non-combustible aerosol provision system, the apparatus comprising:
a charging unit configured to charge a battery of said non-combustible aerosol provision system;
a circuit comprising a control module, wherein the control module outputs a first control signal having a charge enable state and a charge disable state; and
a protection module configured to decouple the circuit from said battery when the battery voltage is below a first threshold level,
wherein:
the charging unit is configured to charge the battery unless the first control signal has the charge disable state; and
the protection module is configured to prevent the battery from being charged when the battery voltage is below a second threshold level, wherein the second threshold level is lower than the first threshold level.

2. The apparatus of claim 1, wherein the protection circuit is configured to permanently decouple the circuit from said battery when the battery voltage is below the second threshold level.

3. The apparatus of claim 1,
wherein the control module is configured to output a charge current control signal.

4. The apparatus of claim 3, wherein a charging current output by the charging unit to charge the battery is dependent, at least in part, on the charge current control signal.

5. The apparatus of claim 4, wherein the charging current output is set to a default level in the absence of the charge current control signal.

6. The apparatus of claim 3, wherein the charge current control signal is dependent, at least in part, on a temperature of said battery.

7. The apparatus of claim 1, wherein the control module is configured to set the first control signal to the charge enable state or the charge disable state based, at least in part, on a determined temperature of said battery.

8. The apparatus of claim 1, wherein generation of an aerosol by the apparatus causes the control module to set the first control signal to the charge disable state.

9. The apparatus of claim 1, further comprising a resistor arrangement, wherein the resistor arrangement is configured to receive the first control signal from the control module and to receive a constant current source signal from the charging unit, wherein the constant current source signal generates a voltage within the resistor arrangement dependent on said first control signal, said voltage being used, by said charging unit, to determine whether to allow charging of said battery.

10. The apparatus of claim 9, wherein the resistor arrangement comprises:
a first resistor having a first terminal configured to receive the constant current source signal and a second terminal connected to ground; and
a second resistor having a first terminal configured to receive the constant current source signal and a second terminal configured to receive the first control signal.

11. The apparatus of claim 1, further comprising a regulator configured to regulate an operational voltage provided to said circuit.

12. The apparatus of claim 1, wherein the control module is configured to control an aerosol generation circuit of said apparatus.

13. The apparatus of claim 1, further comprising said battery.

14. A non-combustible aerosol provision system comprising an apparatus as claimed claim 1.

15. The non-combustible aerosol provision system of claim 14, wherein the aerosol provision system is configured to receive a removable article comprising an aerosol generating material.

16. A method comprising:
detecting that a voltage of a battery of non-combustible aerosol provision system is below a first threshold level and decoupling a circuit from the battery in response, wherein the circuit comprises a control module;
preventing the battery from being charged when the battery voltage is below a second threshold level, wherein the second threshold level is lower than the first threshold level;
using said control module to generate a first control signal, the first control signal having a charge enable state and a charge disable state; and
charging the battery unless the first control signal has the charge disable state.

17. The method of claim 16, wherein
decoupling the circuit from the battery causes the control signal to lack either of the charge enable state or the charge disable state.

18. The method of claim 16,
further comprising detecting that the battery voltage is below the second threshold level and permanently decoupling the circuit from the battery.

19. The method of claim 16, further comprising:
generating a voltage within a resistor arrangement dependent on said first control signal; and
determining whether to charge the battery depending on said generated voltage.
